(19) United States
(12) Patent Application Publication
(10) Pub. No.: US 2017/0167222 A1
(43) Pub. Date: Jun. 15, 2017

(54) METHOD AND COMPOSITION FOR CONTROLLING FRACTURE GEOMETRY

(71) Applicant: Schlumberger Technology Corporation, Sugar Land, TX (US)

(72) Inventors: Wingki Lee, Houston, TX (US); Bruno Lecerf, Houston, TX (US)

(21) Appl. No.: 14/964,975

(22) Filed: Dec. 10, 2015

(51) Int. Cl. E21B 33/138; C09K 8/62; C09K 8/80; E21B 43/26; E21B 43/267

(52) U.S. Cl. CPC E21B 33/138; E21B 43/26; E21B 43/267; C09K 8/80; C09K 8/62; C09K 2208/08

(57) ABSTRACT

A method for treating a subterranean formation and for controlling a fracture geometry of a fracture in a subterranean formation. The treatment includes injection of a treatment fluid comprising particles having different sizes and a fiber that does not allow for the particles to settle in a near wellbore area. The treatment fluid triggers particle bridging in the far field.

### BACKGROUND

Hydrocarbons (oil, condensate and gas) are typically produced from wells that are drilled into the formations containing them. For a variety of reasons, such as inherently low permeability of the reservoirs or damage to the formation caused by drilling and completion of the well, the flow of hydrocarbons into the well may be low. In this case, the well can be stimulated, using a variety of techniques, including hydraulic fracturing.

During the drilling of a wellbore, various fluids may be used for multiple functions. The fluids may be circulated through a drill pipe and a drill bit into the wellbore, and then may subsequently flow upward through the wellbore to the surface. During the circulation, the fluid may act to remove drill cuttings from the bottom of the hole to the surface, to suspend cuttings and weighting material when circulation is interrupted, to control subsurface pressures, to maintain the integrity of the wellbore until the well section is cased and cemented, to isolate fluids from the formation by providing a sufficient hydrostatic pressure to prevent the ingress of the fluids into the wellbore, to cool or lubricate the drill string and drill bit, and/or to maximize a penetration rate.

In hydraulic fracturing in particular, a fluid is injected into the formation to initiate and propagate a fracture. A second fluid may subsequently be injected to keep the fracture open after the pressure is released. During hydraulic fracturing, one or more of the fluids will be pumped into the wellbore until the downhole pressure exceeds the fracture gradient of the rock.

Fibers have been used in some hydraulic fracturing treatments where a viscosified treatment fluid is used to carry proppant and/or where bridging contributed by the fiber is desirable, e.g., in diversion applications.

The process of bridging or plugging of fractures refers to intentionally or accidentally plugging off pore spaces or fluid paths in a rock formation, or to make a restriction in a wellbore or annulus. A bridge may be partial or total, and can be caused by solids (drilled solids, cuttings, cavings or junk) becoming lodged together in a narrow spot or geometry change in the wellbore. Plugging fractures by bridging of particles can be performed so as to control adverse fracture height growth and length growth that may be created during hydraulic fracturing treatments. However, bridging may occur prematurely, which can lead to a screen out, or an undesirable amount of proppant, in the near wellbore region.

### SUMMARY

The application includes a method of providing a fracturing treatment to a subterranean formation. The method includes injecting the subterranean formation with a treatment fluid. The treatment fluid includes at least two sets of particles, the two sets of particles having different average particle sizes, and a fiber that does not allow for the particles to settle in a near wellbore area. The treatment fluid triggers particle bridging in the far field.

The application further includes a method for controlling fracture geometry of a fracture in a subterranean formation. The method includes injecting the subterranean formation with a treatment fluid. The treatment fluid includes at least two sets of particles, the two sets of particles having different average particle sizes, and a fiber that does not allow for the particles to settle in a near wellbore area. The treatment fluid triggers particle bridging in the far field. The method also includes plugging the fracture in the far field, thereby controlling adverse fracture geometry changes.

### DETAILED DESCRIPTION OF EMBODIMENTS

In the following description, numerous details are set forth to provide an understanding of the present disclosure. However, it may be understood by those skilled in the art that the methods of the present disclosure may be practiced without these details and that numerous variations or modifications from the described embodiments may be possible.

At the outset, it should be noted that in the development of any such actual embodiment, numerous implementation-specific decisions may be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context. The term about should be understood as any amount or range within 10% of the recited amount or range (for example, a range from about 1 to about 10 encompasses a range from 0.9 to 11). Also, in the summary and this detailed description, it should be understood that a range listed or described as being useful, suitable, or the like, is intended to include support for any conceivable sub-range within the range at least because every point within the range, including the end points, is to be considered as having been stated. For example, “a range of from 1 to 10” is to be read as indicating each possible number along the continuum between about 1 and about 10. Furthermore, one or more of the data points in the present examples may be combined together, or may be combined with one of the data points in the specification to create a range, and thus include each possible value or number within this range. Thus, (1) even if numerous specific data points within the range are explicitly identified, (2) even if reference is made to a few specific data points within the range, or (3) even when no data points within the range are explicitly identified, it is to be understood (i) that the inventors appreciate and understand that any conceivable data point within the range is to be considered to have been specified, and (ii) that the inventors possessed knowledge of the entire range, each conceivable sub-range within the range, and each conceivable point within the range. Furthermore, the subject matter of this application illustratively disclosed herein suitably may be practiced in the absence of any element(s) that are not specifically disclosed herein.

The following definitions are provided in order to aid those skilled in the art in understanding the detailed description.

The term “injecting” describes the introduction of a new or different element into a first element. In the context of this application, injection of a fluid, solid or other compound may occur by any form of physical introduction, including but not limited to pumping.

The term “fracturing” refers to the process and methods of breaking down a geological formation and creating a fracture in the geological formation, including in a geological formation around a wellbore, in order to increase production rates from a hydrocarbon reservoir. The fracturing methods otherwise use techniques known in the art. Fractures can also be natural fractures that already existed in the rock. Those natural fractures may be opened as a result of the net pressure developing in the main fracture during the treatment.

A composition can be used in some or all portions of the subterranean formation penetrated by a wellbore, including portions that are substantially distanced from the wellbore. The terms “substantially distanced from the wellbore,” or “far field,” may refer to any portion of the subterranean formation that is not near wellbore, outside of a perforation tunnel or outside of a formation face in openhole configuration. These portions of the subterranean formation may be beyond the range where conventional diverting agents can reach. For example, far field may refer to the subterranean zone that is from about 10 feet to about 3000 feet from a wellbore or perforation tunnel, or from about 100 to about 1000 feet from a wellbore or perforation tunnel. The terms “substantially distanced from the wellbore,” or “far field,” may refer to any portion of the subterranean formation that is not near wellbore, outside of a perforation tunnel or outside of a formation face in openhole configuration. These portions of the subterranean formation may be beyond the range where conventional diverting agents can reach. For example, far field may refer to the subterranean zone that is from about 10 feet to about 3000 feet from a wellbore or perforation tunnel, or from about 100 to about 1000 feet from a wellbore or perforation tunnel. A zone within the far field may further be a distance of about 30 feet or more from the wellbore surface, or about 50 feet or more from the wellbore surface, or 50 to 100 feet from the wellbore surface.

The term “degradable materials” refers to a material that will at least partially degrade (for example, by cleavage of a chemical bond) within a desired period of time such that no additional intervention is used to remove the plug. For example, at least 30% of the material may degrade, such as at least 50%, or at least 75%. In some situations, 100% of the material may degrade. The degradation of the material may be triggered by a temperature change, and/or by chemical reaction between the material and another reactant. Degradation may include dissolution of the material.

The term “fracture geometry” relates to the form, shape, size and/or other properties of a wellbore fracture. This may include the length and height of the wellbore fracture.

A diverting or plugging operation may involve controlling a particular fracture, perforation or opening by injecting a plugging material into an appropriate location, so as to, for example, protect from fluid loss at the fracture or perforation. The fracture which is plugged may be a fracture intersecting the wellbore, or a fracture that intersects an existing fracture at a distance away from the wellbore. One may want to plug a fracture that is intentionally induced, or a natural fracture of the rock. The diversion or plugging operation may occur by using a fluid having particular materials.

In hydraulic and acid fracturing treatments, a first fluid which typically does not contain any solid, called a pad, is injected into the formation to initiate and propagate a fracture. Then, a second fluid is injected to keep the fracture open after the pressure is released. The second fluid generally contains a proppant, such as sand. In acid fracturing, the second fluid also contains an acid or chelating agent that can dissolve part of the rock, which may cause irregular etching of the fracture face and removal of some of the mineral matter. This may result in the fracture not completely closing when the pumping is stopped.

A plugging operation may be used during the hydraulic or acid fracturing process. In some embodiments, a plugging operation directed to plugging fractures in the far field is provided. Such an operation may involve providing a fluid, otherwise referred to herein as a treatment fluid. The fluid may be provided into the subterranean formation by injection at some time during the fracturing treatment.

In some embodiments, the treatment fluid may be pumped or injected into the subterranean formation before additional proppant is injected into the subterranean formation. The treatment fluid may follow the pad. The treatment fluid may be of a volume ranging from 1% to 30% of the total amount of the volume of the fracturing treatment, or from 5% to 15%. In some embodiments, the treatment fluid is pumped or injected into the subterranean formation at an early stage of pumping proppant. The plugging operation includes pumping the treatment fluid with the first fraction of proppant-laden fracturing fluid. The fraction of the proppant laden fluid which contains the treatment fluid may be of a volume ranging from 1 to 30% of the fracturing treatment, or from 5 to 15%.

The treatment fluid may comprise a fiber and at least two sets of particles. The fiber may be a fiber that does not allow for bridging in a near wellbore area, which may suspend the particles and prevent them from settling in the near wellbore area, though the fiber may allow for bridging of particles in the far field. The fiber may also be a fiber that may allow for some bridging in various areas, provided that particles may still ultimately also be bridged in the far field.

In some embodiments, the treatment fluid includes degradable fibers and/or degradable particles, but some embodiments may allow for nondegradable fibers and/or particles to be used. In embodiments using degradable fibers, the degradation process may be delayed so that the particle bridging occurs only at the far field. Accordingly, by bridging particles at the far field, there may be a plugging of a fracture in a far field region.

In some embodiments, the treatment fluid comprises from 1.2 to 12 g/L of the fibers based on the total volume of the carrier fluid (from 10 to 100 ppt, pounds per thousand gallons of carrier fluid), or from 1.2 to 4.8 g/L of the fibers based on the total volume of the carrier fluid (from 10 to 40 ppt) or from 1.2 or 2.4 to 4.8 g/L of the fibers based on the total volume of the carrier fluid (from 10 or 20 to 40 ppt).

In some embodiments, the fibers are crimped staple fibers. In some embodiments, the crimped fibers comprise from 1 to 10 crimps/cm of length, a crimp angle from 45 to 160 degrees, an average extended length of fiber of from 4 to 15 mm, and/or a mean diameter of from 8 to 40 microns, or 8 to 12 microns, or 8 to 10 microns, or a combination thereof. In some embodiments, the fibers comprise low crimping equal to or less than 5 crimps/cm of fiber length, e.g., 1-5 crimps/cm.

Depending on the temperature that the treatment fluid will encounter, especially at downhole conditions, the fibers may be chosen depending on their resistance or degradability at the envisaged temperature. In the present disclosure, the terms “low temperature fibers,” “mid temperature fibers” and “high temperature fibers” may be used to indicate the temperatures at which the fibers may be used for delayed degradation, e.g., by hydrolysis, at downhole conditions. Low temperatures are typically within the range of from about 60° C. (140° F.) to about 93° C. (200° F.); mid temperatures typically from about 94° C. (201° F.) to about 149° C. (300° F.); and high temperatures typically about 149.5° C. (301° F.) and above, or from about 149.5° C. (301° F.) to about 204° C. (400° F.).

In some embodiments, the fibers comprise polyester. In some embodiments, the polyester undergoes hydrolysis at a low temperature of less than about 93° C. as determined by slowly heating 10 g of the fibers in 1 L deionized water until the pH of the water is less than 3, and in some embodiments, the polyester undergoes hydrolysis at a moderate temperature of between about 93° C. and 149° C. as determined by slowly heating 10 g of the fibers in 1 L deionized water until the pH of the water is less than 3, and in some embodiments, the polyester undergoes hydrolysis at a high temperature greater than 149° C., e.g., between about 149.5° C. and 204° C. In some embodiments, the polyester is selected from the group consisting of polylactic acid, polyglycolic acid, copolymers of lactic and glycolic acid, and combinations thereof.

In some embodiments, the fibers may be selected from the group consisting of polylactic acid (PLA), polyglycolic acid (PGA), polyethylene terephthalate (PET), polyester, polyamide, polycaprolactam and polylactone, poly(butylene) succinate, polydioxanone, nylon including nylon 6,6, glass, ceramics, carbon (including carbon-based compounds), elements in metallic form, metal alloys, wool, basalt, acrylic, polyethylene, polypropylene, novoloid resin, polyphenylene sulfide, polyvinyl chloride, polyvinylidene chloride, polyurethane, polyvinyl alcohol, polybenzimidazole, polyhydroquinone-diimidazopyridine, poly(p-phenylene-2,6-benzobisoxazole), rayon, cotton, cellulose and other natural fibers, rubber, and combinations thereof.

In embodiments, when PLA is used, any type of PLA may be used, such as poly-D, poly-L or poly-D, L lactic acid, or stereocomplex polylactic (sc-PLA) and mixtures thereof. In embodiments, the PLA may have a molecular weight (Mw) of from about 750 g/mol to about 5,000,000 g/mol, or from 5000 g/mol to 1,000,000 g/mol, or from 10,000 g/mol to 500,000 g/mol, or from 30,000 g/mol to 500 000 g/mol. Gel Permeation Chromatography a.k.a Size Exclusion Chomatography is a common method to determine the molecular weight distribution of a polymer sample. The polydispersity of these polymers might be between 1.5 to 5. The inherent viscosity of PLA that may be used, as measured in hexafluoro-2-propanol at 30° C., with 0.1% polymer concentration, may be from about 1.0 dl/g to 2.6 about dl/g, or from 1.3 dl/g to 2.3 dl/g.

In some embodiments, the PLA may have a glass transition temperature (Tg) above about 20° C., or above 25° C., or above 30° C., or from 35° C. to 55° C. In embodiments, the PLA may have a melting temperature (Tm) below about 140° C., or about 160° C., or about 180° C. or from about 220° C. to about 230° C.

In some embodiments, the fibers may contain silicones. The fibers may contain about 0.1 to 20 wt %, or about 0.1 to 5% of silicones. The fibers may exhibit a high dispersibility while also having a high non-bridging capacity.

In embodiments, the fiber, comprising a polyester and silicones may be in the form of a dual component with a shell and a core. In this configuration at least the shell or the core may contain a polyester and one of the shell and core or both contain 0.1 to 20 wt % of silicones. The two components may have different degradation rate depending on the conditions.

The silicone may be present in the fiber in 0.1 to 20 wt %, or 0.1 to 5 wt %, or 0.1 to 3 wt %. or 0.5 to 3 wt %. The fiber containing silicones in the present context may be understood as polymeric fibers, such a polyester, containing a dispersed phase of silicones. This type of fibers may be obtained for example by mixing melting silicones and melted polymers and then extruding the mixture so that the reparation of silicones may be relatively homogeneous. In embodiments, the fibers may be obtained by extrusion from pellets of thermoplastic material containing silicones and PLA.

Silicones in the present context may be understood broadly. The silicones as used in the disclosure are solid at room temperature (25° C.). As mentioned previously, the polymer part and the silicones part may typically be mixed as solid at room temperature before melt so that a homogeneous distribution can be obtained throughout the polymer fiber. In embodiments, the silicone is obtained from silicate, for example silica, or fumed silica; when fumed silica is used, it may have a specific surface area (BET) above about 30 m²/g, or above 50 m²/g. In embodiments, the silicone used is prepared from polymer containing siloxane and organic radicals.

The silicone may include silicone polymers which may be cyclic polysiloxanes, linear polysiloxanes, branched polysiloxanes, crosslinked polysiloxanes and mixtures thereof.

Linear polysiloxanes that may be used may have the formula:

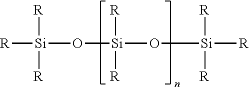

wherein R may be C1-C10 hydrocarbon radical, or alkyl, aryl, etc.

In embodiments cyclic polysiloxanes of the following formula may be used:

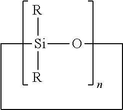

wherein R may be C1-C10 hydrocarbon radical, or alkyl, aryl, and n may be an integer of at least 4, 5 or 6.

In embodiments, branched polysiloxane of the following formula may be used:

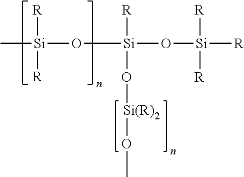

wherein R may be C1-C10 hydrocarbon radical, or alkyl, or aryl, and n may be the same or different and for a number from 10 to 10,000.

In embodiments, cross-linked polysiloxanes of the following formula may be used:

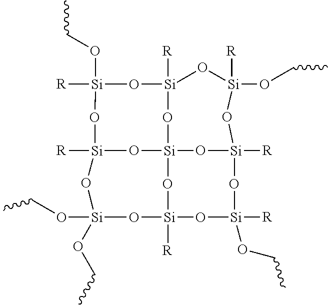

wherein R may be C1-C10 hydrocarbon radical, or alkyl, or aryl,

In embodiments, the silicone used is a linear silicone. In embodiments, such linear silicone has a molecular weight (Mw) of at least about 100,000 g/mol, or at least 150,000 g/mol, or at least 200,000 g/mol and up to about 900,000 g/mol, or up to 700,000 g/mol, or up to 650,000 g/mol, or up to 600,000 g/mol. As noted earlier, Gel Permeation Chromatography is a technique that can be applied to molecular weight determination of polymers—including polysiloxanes. In embodiments, high molecular weight, non-crosslinked, linear silicone polymers used having, at 25° C., a density between 0.76 and 1.07 g/cm³, or from 0.9 to 1.07 g/cm³, or from 0.95 to 1.07 g/cm³.

The fibers containing silicone may provide advantageous proppant transport and reduced settling with reduced water requirements (higher proppant loading), reduced proppant requirements (better proppant placement) and reduced power requirements (lower fluid viscosity and less pressure drop). The fibers may increase proppant transport in a low viscosity fluid. The fibers may be degradable after placement in the formation.

The treatment fluid may include a low viscosity carrier fluid having a low viscosity, proppant dispersed in the carrier fluid, and fiber dispersed in the carrier fluid. As used herein, a “low viscosity” fluid refers to one having a viscosity less than 50 mPa-s at a shear rate of 170 s⁻¹ and a temperature of 25° C.

The fibers can be used in hybrid treatments such as heterogeneous proppant placement and/or pulsed proppant and/or fiber pumping operation modes. If desired in some embodiments, the pumping schedule may be employed according to the alternating-proppant loading technology disclosed in U.S. Patent Application Publication No. 2008/0135242, which is hereby incorporated herein by reference in its entirety. In this configuration the treatment fluid is pumped as proppant-laden stages between proppant-lean stages. For example the fluid may be slickwater first, followed adjacently by a proppant-laden pulse (or stage), immediately followed by another proppant-lean stage. In this configuration, the silicones modified fibers may be present only in the proppant-laden stage or may be pumped continuously having thus only the proppant being spaced in a plurality of intervals.

The carrier fluid may be any of fresh water, produced water, seawater or brine. The carrier fluid may also include hydratable gels including polysaccharides, polyacrylamides, and polyacrylamide co-polymers. Still further, the carrier fluid may include crosslinked hydratable gels, viscoelastic surfactant fluids, emulsified acids, energized fluids, viscosified oil, or oil-based fluids. In embodiments where the carrier fluid comprises a gel, the gel may include water soluble polymers, such as hydroxyethylcellulose (HEC), guar, copolymers of polyacrylamide and their derivatives, e.g., acrylamido-methyl-propane sulfonate polymer (AMPS), or a viscoelastic surfactant system, e.g., a betaine, or the like. When a polymer is present, it may be at a concentration below 1.92 g/L (16 ppt), e.g. from 0.12 g/L (1 ppt) to 1.8 g/L (15 ppt). When a viscoelastic surfactant is used, it may be used at a concentration below 10 ml/L, e.g. 2.5 ml/L to 5 ml/L.

In some embodiments, the treatment fluid comprises particles and fibers dispersed in a carrier fluid. The particles may include some proppant particles, but are not limited to only proppant particles. In some embodiments, the treatment fluid will include a carrier fluid, a fiber and a mixture of solid particles having at least two particle sizes. The particle sizes may be distinct from the size of the proppant that is used in a subsequent injection (an injection of proppant-laden slurry). The particle sizes may also include a particle size matching a size of the proppant to be used in a later proppant-laden slurry injection. The particle size that may match the proppant size may be the larger of the particle sizes. The particle size matching the size of the proppant may or may not correspond to the proppant itself.

In a case where proppant is included in the treatment fluid, either as one or more of the particles or otherwise, the treatment fluid comprises from 0.01 to 1 kg/L of proppant based on the total volume of the carrier fluid (from 0.1 to 8.3 ppa, pounds proppant added per gallon of carrier fluid), e.g., from 0.048 to 0.6 kg/L of the proppant based on the total volume of the carrier fluid (0.4 to 5 ppa), or from 0.12 to 0.48 kg/L of the proppant based on the total volume of the carrier fluid (from 1 to 4 ppa). As used herein, proppant loading is specified in weight of proppant added per volume of carrier fluid, e.g., kg/L (ppa=pounds of proppant added per gallon of carrier fluid). Some proppants include ceramic proppant, sand, bauxite, glass beads, crushed nuts shells, polymeric proppant, rod shaped, and mixtures thereof.

In some embodiments, the fiber is dispersed in the carrier fluid in an amount effective to inhibit settling of the proppant. This settling inhibition may be evidenced, in some embodiments, for example, in a static proppant settling test at 25° C. for 90 minutes. The proppant settling test in some embodiments involves placing the fluid in a container such as a graduated cylinder and recording the upper level of dispersed proppant in the fluid. The upper level of dispersed proppant is recorded at periodic time intervals while maintaining settling conditions. The proppant settling fraction is calculated as:

$$Proppant settling = \frac{\begin{matrix}[ initial proppant level ( t = 0 ) ] - \\ [ upper proppant level at time n ]\end{matrix}}{\begin{matrix}[ initial proppant level ( t = 0 ) ] - \\ [ final proppant level ( t = ∞ ) ]\end{matrix}}$$

The fiber inhibits proppant settling if the proppant settling fraction for the fluid containing the proppant and fiber has a lower proppant settling fraction than the same fluid without the fiber and with proppant only. In some embodiments, the proppant settling fraction of the treatment fluid in the proppant settling test after 90 minutes is less than 50%, e.g., less than 40%.

In some embodiments, the fiber is dispersed in the carrier fluid in an amount insufficient to cause bridging in the near-wellbore area, e.g., as determined in a small slot test comprising passing the treatment fluid comprising the carrier fluid and the fiber without proppant at 25° C. through a bridging apparatus comprising a 1.0-2.0 mm slot that is 15-16 mm wide and 65 mm long at a flow rate equal to 15 cm/s, or at a flow rate equal to 10 cm/s. Eventually, once the solid mixture containing the fiber travels far enough, the leakoff of the carrier fluid in the formation will concentrate the solid mixture and the solid mixture will eventually bridge. This may allow for transporting the solid mixture far in the fracture without settling, which can be achieved by the instant fiber which demonstrates some non-bridging characteristics.

In some embodiments, the fiber is dispersed in the carrier fluid in both an amount effective to inhibit settling of the proppant and in an amount insufficient to cause bridging, wherein settling and bridging are determined by comparing proppant accumulation in a narrow fracture flow test comprising pumping the treatment fluid at 25° C. through a 1-2 mm slot measuring 3 m long by 0.5 m high for 60 seconds at a flow velocity of 30 cm/s, or at a flow velocity of 15 cm/s, relative to a reference fluid containing the carrier fluid and proppant only without the fiber. In the narrow fracture flow test, the slot may be formed of flow cells with transparent windows to observe proppant settling at the bottom of the cells. Proppant settling is inhibited if testing of the fluid with the proppant and fiber results in measurably less proppant settling than the same fluid and proppant mixture without the fiber at the same testing conditions. Bridging is observed in the narrow fracture flow test as regions exhibiting a reduction of fluid flow also resulting in proppant accumulation in the flow cells.

In embodiments, in addition to the fiber, the treatment fluid includes at least two sets of differently sized particles. An average particle size of a first set of the particles may be from 100 μm to 2 mm. An average particle size of a second set of the particles may be from 1.5 to 20 times smaller than the average particle size of the first set. That is, an average particle size of the second set may be from 5 μm to 1.33 mm, or from 66.6 μm to 100 μm, or from 5 μm to 100 μm, or from 66.6 μm to 1.33 mm.

One or more of the sets of the particles may be made of a degradable material. One or more of the sets of particles may be comprised of proppants, including glass beads, ceramic beads, sand and bauxite. In some embodiments, the first set of particles is made of degradable material, and the second set of particles is made of proppants. In some embodiments, the first set of particles is made of proppants, and the second set of particles is made of degradable material. In some embodiments, some or all of the particles may be coated with a resin. The type of resin used for the coating may be any suitable resin.

The injection of the treatment fluid into the subterranean formation may serve to pass through a near wellbore area without performing a bridging function, either by virtue of the presence of the fibers or otherwise. The treatment fluid may then perform a bridging function after a predetermined time, or at a predetermined distance. In some embodiments, the bridging of particles occurs in the far field so as to plug the fracture and stop particles from propagating still further into the formation. Such a method may include plugging a fracture or fractures by virtue of the bridging of particles in the far field, and this method as described herein may allow for adverse fracture height and length growth, and fracture geometry generally, to be adequately controlled during subterranean formation treatments.

In embodiments where the carrier fluid comprises brine, the carrier may include sodium chloride, potassium bromide, ammonium chloride, potassium chloride, tetramethyl ammonium chloride and the like, including combinations thereof. In some embodiments the fluid may comprise oil, including synthetic oils, including in an oil-based or invert emulsion fluid.

In some embodiments the treatment fluid may include a fluid loss control agent, e.g., fine solids less than 10 microns, or ultrafine solids less than 1 micron, or 30 nm to 1 micron. According to some embodiments, the fine solids are fluid loss control agents including γ-alumina, colloidal silica, CaCO₃, SiO₂, and bentonite, and may comprise particulates with different shapes such as glass fibers, flocs, flakes, films; and any combination thereof or the like. Colloidal silica, for example, may function as an ultrafine solid loss control agent, depending on the size of the micropores in the formation, as well as a gellant and/or thickener in any associated liquid or foam phase.

In some embodiments, the treatment fluid comprises a friction reducer, e.g., a water soluble polymer. The treatment fluid may additionally or alternatively include, without limitation, clay stabilizers, biocides, crosslinkers, breakers, corrosion inhibitors, temperature stabilizers, surfactants, and/or proppant flowback control additives. The treatment fluid may further include a product formed from degradation, hydrolysis, hydration, chemical reaction, or other process that occur during preparation or operation.

Although the preceding description has been described herein with reference to particular means, materials and embodiments, it is not intended to be limited to the particulars disclosed herein; rather, it extends to all functionally equivalent structures, methods and uses, such are within the scope of the appended claims.

What is claimed is:

1. A method of providing a fracturing treatment to a subterranean formation, comprising:
injecting the subterranean formation with a treatment fluid,
wherein the treatment fluid includes (1) at least two sets of particles, the two sets of particles having different average particle sizes, and (2) a fiber that does not allow for the particles to settle in a near wellbore area, and
wherein the treatment fluid triggers particle bridging in the far field.

2. The method according to claim 1, wherein the fiber is degradable.

3. The method according to claim 1, wherein the fiber is not degradable.

4. The method according to claim 1, wherein the fiber comprises crimped staple fibers.

5. The method according to claim 1, wherein the fiber contains about 0.1 to about 20 wt % silicones.

6. The method according to claim 1, wherein the plurality of particles includes first particles having an average particle size between 100 μm and 2 mm and second particles having an average particle size of between 1.5 and 20 times smaller than that of the first particles.

7. The method according to claim 6, wherein the first and/or the second particles comprise degradable material.

8. The method according to claim 1, further comprising:
pumping a pad into the subterranean formation; and
pumping a proppant-laden slurry into the subterranean formation.

9. The method according to claim 8, wherein the injecting of the subterranean formation with a treatment fluid occurs immediately after the pad is pumped into the subterranean formation and before the proppant is pumped into the subterranean formation.

10. The method according to claim 8, wherein the injecting of the subterranean formation with a treatment fluid occurs while the proppant is pumped into the subterranean formation.

11. A method for controlling fracture geometry of a fracture in a subterranean formation, comprising:
injecting the subterranean formation with a treatment fluid,
wherein the treatment fluid includes (1) at least two sets of particles, the two sets of particles having different average particle sizes, and (2) a fiber that does not allow for the particles to settle in a near wellbore area, and
wherein the treatment fluid triggers particle bridging in the far field; and
plugging the fracture in the far field, thereby controlling adverse fracture geometry changes.

12. The method according to claim 11, wherein the fiber is degradable.

13. The method according to claim 11, wherein the fiber is not degradable.

14. The method according to claim 11, wherein the fiber comprises crimped staple fibers.

15. The method according to claim 11, wherein the fiber contains about 0.1 to about 20 wt % silicones.

16. The method according to claim 11, wherein the plurality of particles includes first particles having an average particle size between 100 μm and 2 mm and second particles having an average particle size of between 1.5 and 20 times smaller than that of the first particles.

17. The method according to claim 11, wherein the first and/or the second particles comprise degradable material.

18. The method according to claim 11, further comprising:
pumping a pad into the subterranean formation; and
pumping a proppant-laden slurry into the subterranean formation.

19. The method according to claim 18, wherein the injecting of the subterranean formation with a treatment fluid occurs immediately after the pad is pumped into the subterranean formation and before the proppant is pumped into the subterranean formation.

20. The method according to claim 18, wherein the injecting of the subterranean formation with a treatment fluid occurs while the proppant is pumped into the subterranean formation.
